(19) United States
(12) Patent Application Publication
(10) Pub. No.: US 2013/0192725 A1
(43) Pub. Date: Aug. 1, 2013

(54) HIGH STRENGTH STEEL SHEET HAVING EXCELLENT WARM STAMP FORMABILITY AND METHOD FOR MANUFACTURING THE SAME

(71) Applicant: Yoshimasa Funakawa, Chiba (JP)

(72) Inventor: Yoshimasa Funakawa, Chiba (JP)

(73) Assignee: JFE STEEL CORPORATION, Tokyo (JP)

(21) Appl. No.: 13/639,272

(22) PCT Filed: Apr. 11, 2011
(86) PCT No.: PCT/JP2011/059459

§ 371 Date: Dec. 17, 2012

(30) Foreign Application Priority Data
Apr. 9, 2010 (JP) 2010-090796

(51) Int. Cl. C21D 8/02; C22C 38/12; C22C 38/00; C22C 38/04; C22C 38/02; C22C 38/14; C22C 38/06

(52) U.S. Cl. CPC C21D 8/0263; C22C 38/14; C22C 38/12; C22C 38/06; C22C 38/04; C22C 38/02; C22C 38/001
USPC 148/537; 148/602; 148/330; 148/337

(57) ABSTRACT

A high strength steel sheet excellent in warm stamp formability and a method for manufacturing the same. The steel has a composition containing, in terms of % by mass, C: 0.01 to 0.2%, Si: 0.5% or lower, Mn: 2% or lower, P: 0.03% or lower, S: 0.01% or lower, Al: 0.07% or lower, and N: 0.01% or lower and further containing one or two or more elements selected from Ti, Nb, V, Mo, W, and B.

### RELATED APPLICATIONS

This is a §371 of International Application No. PCT/JP2011/059459, with an international filing date of Apr. 11, 2011 (WO 2011/126154 A1, published Oct. 13, 2011), which is based on Japanese Patent Application No. 2010-090796, filed Apr. 9, 2010, the subject matter of which is incorporated by reference.

### TECHNICAL FIELD

This disclosure relates to a high strength steel sheet suitable as materials for transportation machinery, materials for construction machinery, and the like and particularly relates to an improvement of warm press formability as automotive parts. The “high strength” used herein refers to a tensile strength TS of 590 MPa or more and preferably 780 MPa or more,

### BACKGROUND

In recent years, an improvement of fuel efficiency of automobiles has been strongly required in terms of a demand for preservation of the global environment and a reduction in weight of automobile bodies has been progressed. For such a reduction in weight of automobile bodies, a reduction in thickness of steels for automotive parts has been strongly demanded and thus the amount of usage of high strength steel sheets has increased.

As the high strength steel sheets, various high strength steel sheets have been proposed in which a high strength is achieved by compounding low temperature transformed products, such as martensite, with ferrite. However, in general, such high strength steel sheets have problems in that the plastic deformation has been suppressed and the ductility (elongation) has decreased as compared to that of mild steel or low strength steel sheets. When the steel sheets are press-formed into complex shapes at room temperatures, problems arise, such as high generation of cracks, and the press forming is difficult. Further, because of high strength, the high strength steel sheets have a problem in that, in the press forming at room temperatures, the shape accuracy of parts decreases due to spring back.

Separately from the high strength steel sheets strengthened by low temperature trans-formed phase, Japanese Unexamined Patent Application Publication No. 2002-322541, for example, has proposed a hot-rolled steel sheet having high formability and excellent uniformity of strength containing C: 0.1% or lower, Mo: 0.05 to 0.6%, and Ti: 0.02 to 0.10%, in which carbides containing Ti and Mo in the range of satisfying Ti/Mo: 0.1 or more in atomic ratio are dispersed and deposited substantially in a ferrite structure. The hot-rolled steel sheet disclosed in JP '541 can be manufactured by a manufacturing method including heating steel having a composition preferably containing C: 0.06% or lower, Si: 0.3% or lower, Mn: 1 to 2%, P: 0.06% or lower, S: 0.005% or lower, Al: 0.06% or lower, N: 0.06% or lower, Cr: 0.04 to 0.5%, Mo: 0.05 to 0.5%, Ti: 0.02 to 0.10%, and Nb: 0.08% or lower and satisfying Ti/Mo: 0.1 or more in atomic ratio to an austenite single phase temperature range, completing finish rolling at 880° C. or higher, and coiling the steel at 550 to 700° C. The tensile strength of the steel sheet is 590 MPa or more, but the steel sheet has high formability and thus can be subjected particularly to press forming of a member having a complex cross sectional shape at room temperatures.

As one method for solving problems in cold press forming of high strength steel sheets, a die quench method has been proposed. The die quench method is a press method including heating a steel sheet, to an austenite temperature range of 900° C. or higher, and press forming the steel sheet into a desired part shape using a press die, in which the steel sheet (parts) can be quenched by a die simultaneously during the pressing. Thus, the steel sheet can be formed into a desired part shape, the structure can be formed into a structure mainly containing martensite by quenching by a die, and high strength parts can be manufactured with high shape accuracy. However, according to the die quench method, since the steel sheet is heated and formed at high temperatures, the following problems inevitably arise: oxide scales are generated on the surface to reduce the surface properties or, in the case of a coated steel sheet, the steel sheet is exposed to a high temperature to deteriorate a coating layer, for example. Furthermore, according to the die quench method, the steel sheet needs to hold for 10 s or more within the die to sufficiently quench the steel sheet. Therefore, the die quench method has a problem that the productivity excessively decreases.

For such problems, there is a former warm press method including heating a steel sheet, to about 200° C., and then press forming the same. However, according to that method, because of low temperature, a reduction rate of the steel sheet strength during press forming is insufficient, and an increase rate of ductility is also insufficient, and thus the generation of cracks during press forming cannot be avoided and a spring back occurs at the same level of that of press forming at room temperature.

Then, a method including heating a steel sheet, to a warm range of higher than 200° C. and preferably 300° C. or higher and about 850° C., and press forming the same is considered to be a method for solving the problems of the former warm press method.

Japanese Patent No. 3962186, for example, discloses a method for obtaining high strength pressed parts utilizing warm press forming at a temperature higher than that of the former press forming. The method for manufacturing high strength press formed parts disclosed in JP '186 is a method for performing warm forming including heating a steel sheet to a temperature of 200 to 850° C., and giving plastic strain of 2% or more to a position requiring strength. According to the method, by heating a steel sheet to a specific temperature range and imparting a given amount of plastic strain thereto in combination, a desired high strength can be obtained. The steel sheet for use in the technique disclosed in JP '186 is a steel sheet having a composition containing C: 0.01 to 0.20%, Si: 0.01 to 3.0%, Mn: 0.1 to 3.0%, P: 0.002 to 0.2%, S: 0.001 to 0.020%, Al: 0.005 to 2.0%, N: 0.002 to 0.01%, and Mo: 0.01 to 1.5% and further containing one or two or more elements of Cr: 0.01 to 1.5%, Nb: 0.005 to 0.10%, Ti: 0.005 to 0.10%, V: 0.005 to 0.10%, and B: 0.0003 to 0.005%, in which a specific relational equation between the contents of Si, P, Mo, Cr, Nb, Ti, V, and B satisfies Equation (A), which is equal to or lower than a given value (140 or lower).

When a warm press method including heating to a temperature ranging from higher than 200° C. to about 850° C., and press forming is applied to various high strength steel sheets containing low temperature transformed phase, the steel sheets are heated to a temperature higher than the manufacturing temperature and, thus, the steel sheet strength decreases, which facilitates press forming. However, a strengthened structure factor such as martensite is decomposed during heating. Therefore, the method has a problem in that a desired high strength cannot be maintained when cooled to room temperature after warm pressing.

When such a warm press method is applied to the steel sheet manufactured by the technique disclosed in JP '541, there arises a problem in that a bulge-formed position is easily cracked.

The technique disclosed in JP '186 also achieves an increase in strength by heating a steel sheet to a specific temperature range and imparting plastic strain equal to or higher than a specific amount thereto in combination as essential processes. Therefore, according to that technique, a desired high strength cannot be obtained in parts in which a processing and forming amount is lower than a necessary value. Furthermore, there arises a problem in that since the strain amount generally varies according to positions even within parts, the strength does not always uniformly increase and, thus, the practical use thereof is greatly limited.

It could therefore be helpful to provide a high strength steel sheet having a tensile strength TS of 590 MPa or more and preferably 780 MPa or more that has excellent warm formability, can be subjected to a warm press method including heating the steel sheet to a temperature ranging from higher than 200° C. to about 850° C., and press forming the same at the temperature, does not require holding in a die for a long period of time during processing, and can provide parts having a desired high strength irrespective of the warm processing condition and a method for manufacturing the same.

### SUMMARY

We provide:

(1) A high strength steel sheet with excellent warm stamp formability is a steel sheet having a high strength of a tensile strength of 590 MPa or more, in which the steel sheet has tensile properties in which the strain from the maximum load to fracture is larger than the strain before the maximum load from the start of tensile test carried out at a temperature of 400° C. or higher and the strain before the maximum load from the start of tensile test is 40% or more in terms of ratio to the total elongation from the start of tensile test to fracture obtained carried out at a test temperature of lower than 400° C., a matrix, which is substantially a ferrite single phase in which the area ratio of the ferrite phase is 95% or more, and a structure in which alloy carbides having a size of lower than 10 nm are dispersed and deposited in the matrix in a state having no variant selection.

(2) In (1) above, the high strength steel sheet has a composition containing, in terms of % by mass, C: 0.01 to 0.2%, Si: 0.5% or lower, Mn: 2% or lower, P: 0.03% or lower, S: 0.01% or lower, Al: 0.07% or lower, and N: 0.01% or lower and further containing one or two or more elements selected from Ti: 0.005 to 0.3%, Nb: 0.005 to 0.6%, V: 0.005 to 1.0%, Mo: 0.005 to 0.5%, W: 0.01 to 1.0%, and B: 0.0005 to 0.0040% and the balance Fe with inevitable impurities.

(3) In (1) or (2) above, the high strength steel sheet has a coated layer on the surface.

(4) In (3) above, in the high strength steel sheet, the coated layer is a galvanized layer or a galvannealed layer.

(5) A method for manufacturing a high strength steel sheet which has a tensile strength of 590 MPa or more with excellent warm stamp formability includes successively performing a hot rolling process including heating a steel having a composition containing, in terms of % by mass, C: 0.01 to 0.2%, Si: 0.5% or lower, Mn: 2% or lower, P: 0.03% or lower, S: 0.01% or lower, Al: 0.07% or lower, and N: 0.01% or lower and further containing one or two or more elements selected from Ti: 0.005 to 0.3%, Nb: 0.005 to 0.6%, V: 0.005 to 1.0%, Mo: 0.005 to 0.5%, W: 0.01 to 1.0%, and B: 0.0005 to 0.0040% and the balance Fe with inevitable impurities to an austenite single phase temperature range, subjecting the steel sheet to hot-rolling at a finishing temperature of 860° C. or higher, and then coiling at a temperature of 400° C. or higher and lower than 600° C. to form a hot rolled sheet and a heat treatment process including removing surface scale of the hot rolled sheet, and subjecting the hot rolled sheet to heat treatment in a temperature range of 650 to 750° C.

(6) In (5) above, the method for manufacturing a high strength steel sheet includes further performing coating treatment to the hot rolled sheet that is subjected to the heat treatment process.

(7) In (5) above, the method for manufacturing a high strength steel sheet includes performing galvanizing or further galvannealing subsequent to the heat treatment process.

A high strength steel sheet with excellent warm stamp formability can be manufactured with ease and at low cost, and industrially remarkable advantageous effects are demonstrated. Moreover, our steel sheets have an advantageous effect in which high strength parts for automobiles having a desired high strength and a desired shape accuracy can be manufactured with ease and at low cost by the application of warm press forming.

### DETAILED DESCRIPTION

We conducted extensive research on the deformation behavior of a steel sheet during warm press forming and found that, first, in a position contacting a die (punch) of a steel sheet, during warm press forming, the temperature sharply decreases due to cool by the die (punch) and the position is subjected to bulge forming at a relatively low temperature (lower than 400° C.) and, in contrast, in a position not contacting a die, a reduction in the temperature of the steel sheet does not occur and the position is subjected to stretch flange forming at a high temperature (400° C. or higher). More specifically, in the warm press forming method in which a steel sheet is heated to a temperature ranging from higher than 200° C. to about 850° C., processing in different temperature ranges is simultaneously performed within the same steel sheet. Therefore, a steel sheet having properties which allow the steel sheet to be processed in different temperature ranges is required for warm press forming.

Then, as a result of further examination, we concluded that when a material (steel sheet) has tensile properties in which the uniform elongation is high at a low temperature of lower than 400° C. and the local elongation is high at a high temperature of 400° C. or higher and has a high strength of a tensile strength TS at ordinary temperature of 590 MPa or more and preferably 780 MPa or more after warm press forming, warm press forming can be applied to the material to thereby manufacture high strength automotive parts having complex shapes.

More specifically, we found that a steel sheet having the following tensile properties is preferable as a steel sheet suitable for warm press forming.

We thus found that a steel sheet suitable for warm press forming is a steel sheet having tensile properties having both the following properties: the uniform elongation (strain at the maximum load) is high at a relatively low temperature (lower than 400° C.) corresponding to a position contacting a die (punch) and being subjected to bulge forming at a relatively low temperature (lower than 400° C.) and the local elongation (strain from the maximum load to fracture) is high at a high temperature (400° C. or higher) corresponding to a position not contacting a die (punch) and being subjected to bulge forming at a high temperature (400° C. or higher) is high.

According to yet a further examination, we found that the steel sheet having the above-described tensile properties is a steel sheet having a matrix which is substantially a ferrite single phase, i.e., a matrix in which the ferrite fraction is 95% or more and preferably 98% or more, and having a structure in which alloy carbides (deposit) under 10 nm are dispersed and deposited in the matrix. The carbides are deposited with all the variants to the base phase, i.e., a state of having so-called no variant selection.

The carbides dispersed and deposited in the “state having no variant selection” refer to a state in which orientation of carbides is not uniform to the base phase. In contrast, a “state having variant selection” refers to the case that the orientation of carbides is uniform to the base phase, e.g., observed in interphase precipitation.

We also found that the steel sheet (hot rolled steel sheet) having the above-described structure can be obtained by coiling at a temperature of lower than 600° C. after a hot-rolling, and then subjecting the steel sheet to heat treatment at a temperature range of 650 to 750° C.

Our steel sheets have a high strength of a tensile strength of 590 MPa or more and tensile properties suitable for warm press forming, and particularly ductility in conformity with warm press forming. When the test temperature is a low temperature of lower than 400° C., our steel sheet has tensile properties in which the uniform elongation is larger than the local elongation, i.e., ductility in which the uniform elongation is 40% or more in terms of a ratio to the total elongation. In contrast, when the test temperature is a high temperature of 400° C. or higher, the local elongation is larger than the uniform elongation, i.e., ductility in which the ratio of the local elongation and the uniform elongation exceeds 1.0. Thus, a steel sheet having deformation properties with which the steel sheet is sufficiently adapted to the temperature history of each part of the steel sheet during warm press forming and the formed shape of each part of the steel sheet by a die (punch), i.e., a steel sheet with excellent warm stamp formability, is achieved.

At a position subjected to bulge forming by heating the position to a temperature ranging from higher than 200° C. to about 850° C., and then bringing the position into contact with a die to reduce the steel sheet temperature, bulge forming can be successfully performed when the uniform elongation at a low temperature is higher than the total elongation. In contrast, a position subjected to stretch flange forming does not contact a die and thus a high steel sheet temperature is maintained and, therefore, elongation flange forming can be successively performed when the local elongation at a high temperature is higher than the uniform elongation. Thus, by achieving both the ductility at a low temperature and the ductility at a high temperature, press formation into parts having complex shapes by warm press forming is facilitated. With a steel sheet that cannot satisfy either the ductility at a low temperature or the ductility at a high temperature, parts having desired complex shapes cannot be manufactured by warm press forming.

The “uniform elongation” refers to a strain from the start of tensile test to the maximum load (ratio to the gauge length) determined from the stress-strain curve obtained in a tensile test not depending on test temperatures. The “local elongation” refers to a strain from the maximum load to fracture (ratio to the gauge length) determined from the stress-strain curve obtained in a tensile test not depending on test temperatures. The “total elongation” refers to the total strain from the start of tensile test to fracture (ratio to the gauge length), which is a so-called “total elongation,” determined from the stress-train curve obtained in a tensile test.

The “test temperature is a low temperature of lower than 400° C.” means that a test temperature is 300° C., for example. The “test temperature is a high temperature of 400° C. or higher” is that fact that a test is performed at a test temperature of 500° C. and the tensile properties in the temperature range may be represented.

With respect to the ductility when the test temperature is lower than 400° C., the total elongation, the local elongation, and the uniform elongation are determined from the stress-strain curve obtained by collecting I type test pieces (parallel position width: 10 mm, GL: 50 mm) specified in JIS G 0567 from a steel sheet, and then performing a tensile test based on the regulation of JIS G 0567 at a test temperature of lower than 400° C. (e.g., 300° C.). The cross head speed is 10 mm/min.

In contrast, with respect to the ductility when the test temperature is 400° C. or higher, the total elongation, the uniform elongation, and the local elongation are calculated from the stress-strain curve obtained by collecting I type test pieces (parallel portion width: 10 mm, GL: 50 mm) specified in JIS G 0567 from a steel sheet, heating the test piece to a test temperature of 400° C. or higher (e.g., 500° C.), and then performing a high temperature tensile test at a cross head speed of 10 mm/min based on the regulation of JIS G 0567.

To satisfy the tensile properties (tensile ductility), a steel sheet having a matrix which is substantially a ferrite single phase and having a structure in which alloy carbides having a size of lower than 10 nm are dispersed and deposited in the matrix in a state having no variant selection is manufactured.

The structure of the steel sheet (matrix) is substantially a ferrite single phase. By using a ferrite phase having sufficient ductility as the structure, desired warm press formability can be achieved and also a large reduction in strength due to heating to a warm press forming temperature as in a conventional high strength steel sheet containing a low temperature transformed phase, such as martensite, does not occur. Thus, a desired high strength can be maintained even after warm press forming. “Substantially a ferrite single phase” includes the case of containing a second phase up to 5% in terms of area ratio. More specifically, “substantially a ferrite single phase” means that the ferrite phase is 95% or more in terms of area ratio to the entire structure. When containing the second phase up to 5%, a large reduction in strength due to heating to a warm press forming temperature is not recognized and the advantageous effects of the invention can be demonstrated. The second phase is preferably 2% or lower. Furthermore, the steel sheet has a structure in which alloy carbides having a size of lower than 10 nm are dispersed and deposited in the matrix. When the size of the alloy carbides deposited in the matrix becomes larger, e.g., 10 nm or more, the carbides become coarse, the strength decreases, the local ductility becomes small, and the warm stamp formability decreases. The number of dispersion of the alloy carbides having a size of lower than 10 nm is preferably 5×10¹¹/mm³ or more. The alloy carbides here contains alloy elements, such as Ti, Nb, and V. The alloy carbide here may also be a compound thereof.

The alloy carbides having a size of lower than 10 nm dispersed in the matrix are deposited in a state having no variant selection. A “state having no variant selection” refers to the case where the relationship between the crystal orientation of the ferrite and the crystal orientation of the alloy carbides is not constant and the direction is not fixed in one direction.

Due to the fact that the fine alloy carbides are dispersed and deposited in the state having no variant selection, the local elongation becomes larger than the uniform elongation in a tensile test at a high temperature and the uniform elongation becomes larger than the local elongation in a tensile test at a low temperature, and thus a steel sheet suitable for warm press forming can be manufactured. In contrast, in the case of a steel sheet in which fine alloy carbides are dispersed and deposited in the state having variant selection, tensile properties (ductility) in which the local elongation is larger than the uniform elongation cannot be secured particularly at a high temperature.

Next, the limitation reason for the preferable composition of the steel sheet will be described.

The steel sheet preferably has a composition containing, in terms of % by mass, C: 0.01 to 0.2%, Si: 0.5% or lower, Mn: 2% or lower, P: 0.03% or lower, S: 0.01% or lower, Al: 0.07% or lower, and N: 0.01% or lower and further containing one or two or more elements selected from Ti: 0.005 to 0.3%, Nb: 0.005 to 0.6%, V: 0.005 to 1.0%, Mo: 0.005 to 0.5%, W: 0.01 to 1.0%, and B: 0.0005 to 0.0040% and the balance Fe with inevitable impurities. Hereinafter, unless otherwise specified, % by mass is simply indicated as %.
C: 0.01 to 0.2%

C is the most important element that font's a carbide and increases the strength of a steel sheet. C is deposited as a fine carbide in a matrix in processes before forming processing in warm press forming, particularly in heat treatment after hot rolling, and contributes to an increase in strength of parts. C is preferably contained in a concentration of 0.01% or more to obtain such an advantageous effect. In contrast, when the content exceeds 0.2%, it becomes difficult to substantially achieve a ferrite single phase in the matrix and a reduction in ductility becomes remarkable. Therefore, C is preferably limited to 0.01 to 0.2%. C is more preferably 0.18% or lower. According to a desired strength level, the C amount can be generally specified. For example, in a grade of a tensile strength TS of 590 MPa, C is preferably 0.01% or more and 0.03% or lower. In a grade of a tensile strength TS of 780 MPa, C is preferably more than 0.03% and 0.06% or lower. In a grade of a tensile strength TS of 980 MPa, C is preferably more than 0.06% and 0.09% or lower. In a grade of a tensile strength TS of 1180 MPa, C is preferably more than 0.09% and 0.2% or lower.
Si: 0.5% or lower

Si is an element that generally increases tempering softening resistance and thus is positively added. However, Si is preferably reduced as much as possible to promote degradation of surface properties or deposition of alloy carbides with variant selection. Moreover, since Si increases deformation resistance in warm working, an increase in elongation is blocked. Thus, Si is preferably limited to 0.5% or lower. Si is more preferably 0.3% or lower and still more preferably 0.1% or lower.
Mn: 2% or lower

Mn is an element having the action of forming a solid solution to increase the strength of a steel sheet. Mn is preferably contained in a proportion of 0.1% or more to obtain such an advantageous effect. When the content exceeds 2%, segregation becomes remarkable and hardenability increases so that it becomes difficult to achieve a ferrite single phase as the structure. Therefore, Mn is preferably limited to 2% or lower. Mn is more preferably 0.1 to 1.6%.
P: 0.03% or lower

P is an element that effectively contributes to an increase in strength of a steel sheet by solid solution strengthening, but is easily segregated in the grain boundary to thereby cause remarkable cracks during press forming. Therefore, P is preferably reduced as much as possible. When P is reduced to about 0.03% or lower, such an adverse effect is reduced to a permissible level. Thus, P is preferably 0.03% or lower. P is more preferably 0.02% or lower.
S: 0.01% or lower

S forms MnS, promotes generation of voids during press forming, then reduces warm stamp formability. Therefore, S is preferably reduced as much as possible. Such an adverse effect can be reduced to a permissible level when S is reduced to about 0.01% or lower. Therefore, S is preferably limited to 0.01% or lower. S is more preferably 0.002% or lower.
Al: 0.07% or lower

Al is an element that acts as a deoxidizing agent. Al is preferably contained in a concentration of 0.01% or more to obtain such an advantageous effect. However, the content of more than 0.07% easily increases oxide inclusions, reduces the cleanliness of steel, and reduces the warm stamp formability of steel. Therefore, Al is preferably limited to 0.07% or lower. Al is more preferably 0.03 to 0.06%.
N: 0.01% or lower

N is an element having an adverse effect such as a reduction in local elongation due to coarse TiN. Thus, N is preferably reduced as much as possible. A content of more than 0.01% causes formation of coarse nitrides and reduces formability. Therefore, N is preferably limited to 0.01% or lower. N is more preferably 0.005% or lower.

One or two or more elements selected from Ti: 0.005 to 0.3%, Nb: 0.005 to 0.6%, V: 0.005 to 1.0%, Mo: 0.005 to 0.5%, W: 0.01 to 1.0%, and B: 0.0005 to 0.0040%

Ti, Nb, V, Mo, W, and B are all elements that constitute fine carbides or promotes precipitation and one or two or more elements selected therefrom is/are preferably contained. To obtain such an advantageous effect, it is preferable to contain each of Ti: 0.005% or more, Nb: 0.005% or more, V: 0.005% or more, Mo: 0.005% or more, W: 0.01% or more, and B: 0.0005% or more. In contrast, the content of more than each of Ti: 0.3%, Nb: 0.6%, V: 1.0%, Mo: 0.5%, W: 1.0%, and B: 0.0040%, the warm stamp formability is reduced due to solid solution strengthening. Therefore, when contained, it is preferable to limit each element to Ti: 0.005 to 0.3%, Nb: 0.005 to 0.6%, V: 0.005 to 1.0%, Mo: 0.005 to 0.5%, W: 0.01 to 1.0%, and B: 0.0005 to 0.0040%.

As a combination for forming fine carbides (alloy carbides), the combinations of Ti-Mo, Nb—Mo, Ti—Nb—Mo, Ti—W, and Ti—Nb—Mo—W are more preferable. Particularly when V and Ti are contained in combination, a fine carbide, which is the target, is easily obtained by achieving a V/Ti ratio of 1.75 or lower in terms of mass ratio.

The balance other than the ingredients mentioned above contain Fe and inevitable impurities. As the inevitable impurities, Cu: 0.1% or lower, Ni: 0.1% or lower, Sn: 0.1% or lower, Mg: 0.01% or lower, Sb: 0.01% or lower, and Co: 0.01% or lower each are permitted, for example.

Next, a preferable method for manufacturing a steel sheet will be described.

A steel having the above-described composition is used as a starting material. A method for manufacturing a steel is not necessary particularly limited and, in general, known manufacturing methods can all be applied. For example, it is preferable to smelt molten steel having the above-described composition in a revolving furnace or the like to form a steel such as slab by casting methods such as a continuous casting method, but the method is not limited thereto. There arises no problem even when, after the continuous casting, the steel such as slab is charged in a heating furnace and hot rolled without cooling the steel to room temperature or the steel is subjected to hot direct rolling without heating.

First, the steel is heated to an austenite single phase temperature range of preferably 1150° C. or higher to sufficiently solute alloy carbides and the like in the steel. When the heating temperature is lower than 1150° C., the deformation resistance is excessively high and the load to a hot rolling mill becomes high, which sometimes results in a difficulty of hot rolling. When the heating temperature exceeds 1300° C. (high temperature), coarsening of austenite crystal grains is remarkable and generation of oxide scale on slab surface becomes remarkable, so that oxidization loss is high, which results in the fact that a reduction in yield becomes remarkable. Therefore, the heating temperature is preferably 1300° C. or lower. Therefore, the heating temperature of the steel is preferably 1150 to 1300° C.

As described above, the steel heated to the austenite single phase temperature range is subsequently subjected to a hot rolling process. In the hot rolling process, hot rolling in which the rolling end temperature is 850° C. or higher is performed to the steel to form a hot rolled sheet, and then the hot rolled sheet is coiled at a temperature of 400° C. or higher and lower than 600° C.

When the rolling end temperature is lower than 850° C., the surface structure becomes coarse and the warm stamp formability decreases. Therefore, the rolling end temperature is preferably 850° C. or higher. The finishing temperature is more preferably 880 to 940° C.

After completion of rolling, the hot rolled sheet is coiled at a temperature of 400° C. or higher and lower than 600° C. When the coiling temperature is lower than 400° C., a martensite phase is generated and thus a structure of substantially a ferrite single phase cannot be achieved and also alloy carbides easily become coarse, which makes it difficult to obtain fine carbides. In contrast, when the coiling temperature is 600° C. or higher, alloy carbides with variant selection are generated in the steel sheet, which makes it impossible to secure desired warm stamp formability. The coiling temperature is preferably lower than 550° C. and more preferably 530° C. or lower.

In the case of the hot rolling conditions in our range, fine (lower than 10 nm) alloy carbides are hardly deposited after the hot rolling process and dispersion and deposition in the state having no variant selection are not observed.

Surface scale is removed from the hot rolled sheet by pickling or the like after the hot rolling process. Thereafter, a heat treatment process is performed. In the heat treatment process, the hot rolled sheet is subjected to heat treatment in which the hot rolled sheet is held at a temperature of 650 to 750° C. and with a retention time of preferably 10 to 300 s, and then cooled. The cooling process is not necessary particularly limited and air cooling or allowing cooling is preferable. In the heat treatment process, desired alloy carbides are deposited by heat treatment at 650 to 750° C. When the heating temperature is lower than 650° C., deposition of alloy carbides is late and dispersion and deposition in the state having no variant selection of desired alloy carbides under 10 nm are not observed. Moreover, due to the fact that bainite partially remains, it becomes difficult to obtain a matrix of a ferrite single phase. In contrast, at a high temperature of higher than 750° C., the deposition is fast to form coarse alloy carbides, which results in the fact that a desired high strength cannot be secured. Moreover, the structure is partially transformed into austenite to form a ferrite+martensite structure after cooling.

When the heating temperatures are duplicated, the heat treatment during warm press forming can be used in place of the above-described heat treatment. Alloy carbides under 10 nm are not deposited after the forming processing, but have already been deposited before the forming processing during the warm press farming.

The steel sheet to which the heat treatment process is subjected may be further subjected to coating treatment for attaching a coated layer to the surface to form a coated steel sheet. As the coated layer, a galvanized layer, an electrogalvanized layer, a molten aluminum coated layer and the like can all be mentioned.

When a galvanized layer is formed on the hot rolled sheet surface, the heat treatment process is performed by, for example, utilizing preferably a continuous galvanizing line, the resultant steel sheet is cooled to a temperature of about 500° C. or lower, and subsequently galvanizing treatment is performed in which the resultant steel sheet is continuously immersed in a galvanizing bath held at a given temperature of about 470° C., and thus a galvanized layer may be formed on the steel sheet surface. There arises no problem at all even when a common coating line other than the continuous galvanizing line is utilized. Moreover, there arises no problem even when zinc is applied for every steel sheet cut into a desired size, for example.

Moreover, there arises no problem at all even when common coated layer alloying treatment is further performed after the galvanizing treatment to form a galvannealed layer.

Hereinafter, our steel sheets and methods will be described in more detail with reference to Examples.

### EXAMPLES

Steel materials (slabs) of the composition shown in Table 1 were subjected to a hot rolling process for forming a hot rolled sheet having a sheet thickness of 1.6 mm at heating temperatures, finish rolling temperatures, and coiling temperatures of the conditions shown in Table 2, subsequently subjected to pickling for removing scale on the hot rolled sheet surface, and then subjected to a heat treatment process in which heat treatment is performed at heating temperatures, retention times, and cooling conditions of the conditions shown in Table 2. Some hot rolled sheets were cooled to a cooling stop temperature shown in Table 2 without cooling to room temperature in the above-described heat treatment process, and subsequently subjected to galvanizing treatment in which the steel sheets were immersed in a galvanizing bath of a liquid temperature of 470° C. or further subjected to alloying treatment (520° C.) to form a galvanized layer or a galvannealed layer on the surface, and thus a coated sheet was obtained. The deposit amount was 45 g/m².

Test pieces were cut from the obtained hot rolled sheets or the coated sheets, and then structure observation and a tensile test were carried out. The test methods are as follows.

(1) Structure Observation

From the obtained steel sheets, test pieces for structure observation were collected. The cross section (L section) in parallel to the rolling direction was ground, and then subjected to nital corrosion. Then, the cross section was observed for the structure under an optical microscope (magnification: 400 times) and a scanning electron microscope (magnification: 5000 times) and photographed. Then, the type was identified and the structure fraction of each phase was measured using an image analyzer. Furthermore, using thin films prepared from the steel sheets, the ingredients contained in the deposits deposited in a matrix were analyzed with a transmission electron microscope with an energy dispersion X-ray spectroscopy device (EDX) to identify the type of the deposits (alloy carbides) and also investigate the size and the dispersion state of the deposits (alloy carbides). The dispersion state was classified based on whether the deposition was deposition with variant selection or deposition with variant selection.

(2) Tensile Test

From the obtained steel sheets, I type test pieces (parallel-portion width: 10 mm, GL: 50 mm) specified in JIS G 0567 were collected, and then subjected to a tensile test at room temperature (20° C.) based on the regulation of JIS Z 2241 to measure the tensile properties (Yield Strength YS, Tensile Strength TS, Elongation El). Moreover, a tensile test was carried out at a test temperature of lower than 400° C. (300° C.) based on the regulation of JIS G 0567 to determine the total elongation from the start of tensile test to fracture and the strain before the indication of the maximum load from the start of tensile test as the uniform elongation from the obtained stress-strain curve, and then (uniform elongation)/(total elongation) was calculated.

Moreover, from the obtained steel sheets, I type test pieces (parallel-portion width: 10 mm, GL: 50 mm) specified in JIS G 0567 were collected, and then subjected to a high-temperature tensile test at a test temperature of 400° C. or higher (500° C.) based on the regulation of JIS G 0567. From the obtained stress-strain curve, the strain before the indication of the maximum load from the start of tensile test as the uniform elongation and the strain from the indication of the maximum load to fracture as the local elongation were determined, and then the uniform elongation/total elongation was calculated. The test temperature was a value measured by a thermo couple attached to the center of the parallel portion of the test pieces and the test was performed at a cross head speed of 10 mm/min.

In the case where, in the tensile test carried out at a test temperature of lower than 400° C. (300° C.), the uniform elongation/total elongation was 40% or more and, in the tensile test carried out at a test temperature of 400° C. or higher (500° C.), the local elongation / the uniform elongation exceeded 1.0 was graded as O and evaluated to be excellent in warm press formability. The cases other than the above-described case were graded as x and evaluated to be poor in warm press formability.

From the obtained steel sheets, tensile test pieces were collected and then subjected to a tensile test at room temperature while simulating the thermal history of warm press forming including holding at a heating temperature of 700° C. and with a holding time of 3 min and air cooling without processing to measure the tensile strength TS and observe changes in strength due to warm press forming heating.

The obtained results are shown in Table 3.

TABLE 1

| Steel | Chemical composition (% by mass) | | | | | | | | |
|---|---|---|---|---|---|---|---|---|---|
| No. | C | Si | Mn | P | S | Al | N | Ti, Nb, V, Mo, W, B | Remarks |
| A | 0.081 | 0.02 | 0.90 | 0.012 | 0.0005 | 0.033 | 0.0038 | Ti: 0.17, Mo: 0.36 | Compatible Example |
| B | 0.085 | 0.04 | 1.53 | 0.008 | 0.0009 | 0.041 | 0.0025 | Ti: 0.13, V: 0.26 | Compatible Example |
| C | 0.073 | 0.02 | 0.72 | 0.010 | 0.001 | 0.035 | 0.0044 | Ti: 0.11, V: 0.25, B: 0.0006 | Compatible Example |
| D | 0.040 | 0.01 | 1.35 | 0.011 | 0.0005 | 0.041 | 0.0035 | Ti: 0.088, Mo: 0.18 | Compatible Example |
| E | 0.043 | 0.05 | 1.53 | 0.011 | 0.0008 | 0.053 | 0.0031 | Ti: 0.09, V: 0.11 | Compatible Example |
| F | 0.025 | 0.02 | 0.25 | 0.012 | 0.003 | 0.041 | 0.0050 | Ti: 0.08, B: 0.0023 | Compatible Example |
| G | 0.022 | 0.01 | 0.15 | 0.008 | 0.002 | 0.050 | 0.0030 | Nb: 0.15, B: 0.0025 | Compatible Example |
| H | 0.18 | 0.02 | 0.91 | 0.015 | 0.0007 | 0.055 | 0.0038 | Ti: 0.21, V: 0.40, Mo: 0.31 | Compatible Example |
| I | 0.17 | 0.01 | 0.81 | 0.008 | 0.0007 | 0.033 | 0.0051 | Ti: 0.25, V: 0.50, W :0.62 | Compatible Example |
| J | 0.12 | 0.80 | 2.13 | 0.007 | 0.0009 | 0.055 | 0.0059 | — | Comparative Example |

TABLE 2

| | | Hot rolling process | | | Heat treatment process | | | | Galvani- | | |
|---|---|---|---|---|---|---|---|---|---|---|---|
| | | Heating | Finish | Coiling | Heating | | Cooling | | zation | Alloying | |
| Steel | | temper- | rolling | temper- | temper- | | stop | | treatment | treatment | |
| sheet | Steel | ature | temper- | ature | ature | Holding | temper- | Cooling | Done/ | Done/ | |
| No. | No. | ( C.) | ature ( C.) | ( C.) | ( C.) | time (s) | ature ( C.) | method | Not done | Not done | Remarks |
| 1 | A | 1250 | 900 | 525 | 700 | 60 | 470 | Gas cooling | — | — | Example |
| 2 | A | 1220 | 890 | 500 | 720 | 80 | 490 | Gas cooling | — | — | Example |
| 3 | A | 1250 | 900 | 650 | 700 | 40 | 480 | Gas cooling | — | — | Comparative |
| | | | | | | | | | | | Example |
| 4 | A | 1230 | 910 | 350 | — | — | — | — | — | — | Comparative |
| | | | | | | | | | | | Example |
| 5 | A | 1250 | 890 | 520 | 740 | 80 | 500 | Gas cooling | Done | Not done | Example |
| 6 | B | 1230 | 890 | 530 | 680 | 100 | 470 | Gas cooling | — | — | Example |
| 7 | B | 1250 | 920 | 500 | 720 | 80 | 520 | Gas cooling | Done | Done | Example |
| 8 | C | 1280 | 930 | 480 | 700 | 60 | 550 | Gas cooling | Done | Done | Example |
| 9 | D | 1220 | 900 | 450 | 720 | 80 | 450 | Gas cooling | — | — | Example |
| 10 | E | 1230 | 910 | 440 | 740 | 60 | 530 | Roll cooling | Done | Not done | Example |
| 11 | F | 1200 | 900 | 550 | 700 | 90 | 550 | Gas cooling | — | — | Example |
| 12 | G | 1250 | 920 | 430 | 680 | 100 | 520 | Gas cooling | Done | Not done | Example |
| 13 | H | 1280 | 930 | 480 | 700 | 80 | 550 | Roll cooling | — | — | Example |
| 14 | I | 1280 | 910 | 450 | 720 | 90 | 500 | Gas cooling | — | — | Example |
| 15 | J | 1230 | 860 | 400 | 700 | 60 | 520 | Gas cooling | — | — | Comparative |
| | | | | | | | | | | | Example |

TABLE 3

| | | Structure | | | | | | | |
|---|---|---|---|---|---|---|---|---|---|
| | | | | | Alloy carbide | | Tensile properties | | |
| | | | | Second | Done/ | | Yield | Tensile | |
| Steel | | | F | phase | Not-done | | strength | strength | Elon- |
| sheet | Steel | | fraction | fraction | of disper- | Size | YS | TS | gation |
| No. | No. | Type* | (%) | (%) | sion** | (nm) | (MPa) | (MPa) | El (%) |
| 1 | A | F | 100 | — | Done | 3 | 921 | 1010 | 18 |
| 2 | A | F | 100 | — | Done | 4 | 902 | 990 | 17 |
| 3 | A | F + P | 98 | 2 | Not done | 4 | 911 | 1020 | 17 |
| 4 | A | F + B | 5 | 95 | —*** | — | 803 | 1080 | 13 |
| 5 | A | F | 100 | — | Done | 4 | 906 | 985 | 17 |
| 6 | B | F | 100 | — | Done | 3 | 923 | 1035 | 16 |
| 7 | B | F | 100 | — | Done | 4 | 950 | 1088 | 17 |
| 8 | C | F | 100 | — | Done | 3 | 904 | 1033 | 16 |
| 9 | D | F | 100 | — | Done | 2 | 734 | 810 | 20 |
| 10 | E | F | 100 | — | Done | 2 | 750 | 815 | 19 |
| 11 | F | F | 100 | — | Done | 3 | 551 | 610 | 25 |
| 12 | G | F | 100 | — | Done | 3 | 543 | 623 | 26 |
| 13 | H | F | 100 | — | Done | 2 | 1081 | 1231 | 14 |
| 14 | I | F | 100 | — | Done | 2 | 1051 | 1210 | 14 |
| 15 | J | M + F | 15 | 85 | —*** | — | 950 | 1210 | 13 |
| | | | | | Warm press formability | | | | |
| | Tensile properties | | | | Uniform | Local | | Tensile | |
| | Test temperature: | | Test temperature: | | elon- | Elon- | | strength | |
| | 300° C. | | 500° C. | | gation/ | gation/ | | after | |
| | | Total | | Local | Total | Uni- | | warm | |
| Steel | Uniform | elon- | Uniform | elon- | elon- | form | | press | |
| sheet | elongation | gation | elongation | gation | gation | Elon- | Evalu- | forming | |
| No. | (%) | (%) | (%) | (%) | (%) | gation | ation | (MPa) | Remarks |
| 1 | 9.3 | 19 | 5 | 18 | 49 | 3.6 | ∘ | 1050 | Example |
| 2 | 8.9 | 18 | 4 | 17 | 49 | 4.3 | ∘ | 995 | Example |
| 3 | 5.7 | 18 | 8 | 14 | 32 | 1.8 | x | 1031 | Comparative |
| | | | | | | | | | Example |
| 4 | 4.0 | 14 | 12 | 6 | 29 | 0.5 | x | 683 | Comparative |
| | | | | | | | | | Example |
| 5 | 9.1 | 18 | 5 | 18 | 51 | 3.6 | ∘ | 998 | Example |
| 6 | 8.9 | 18 | 5 | 20 | 49 | 4.0 | ∘ | 1041 | Example |
| 7 | 9.8 | 20 | 5 | 21 | 49 | 4.2 | ∘ | 1088 | Example |
| 8 | 9.1 | 19 | 6 | 18 | 48 | 3.0 | ∘ | 1034 | Example |
| 9 | 10.1 | 22 | 8 | 18 | 46 | 2.3 | ∘ | 815 | Example |
| 10 | 10.3 | 23 | 8 | 19 | 45 | 2.4 | ∘ | 820 | Example |
| 11 | 15.1 | 30 | 14 | 21 | 50 | 1.5 | ∘ | 621 | Example |
| 12 | 16.3 | 31 | 15 | 23 | 53 | 1.5 | ∘ | 625 | Example |
| 13 | 9.3 | 17 | 9 | 12 | 55 | 1.3 | ∘ | 1235 | Example |
| 14 | 8.8 | 16 | 9 | 13 | 55 | 1.4 | ∘ | 1205 | Example |
| 15 | 5.0 | 14 | 8 | 10 | 35 | 1.3 | x | 775 | Comparative |
| | | | | | | | | | Example |

*F: Ferrite, M: Martensite, P Perlite, C: Cementite
**Dispersion: Dispersion and deposition without variant selection
***No dispersion and deposition of alloy carbide

All of our Examples have a high strength of 590 MPa or more and (Uniform elongation)/(Total elongation) is 40% or more in the tensile test carried out at a test temperature of lower than 400° C. (300° C.) and (Local elongation)/(Uniform elongation) exceeds 1.0 in the tensile test carried out at a test temperature of 400° C. or higher (500° C.). Thus, our Examples show excellent warm press formability and significant changes in strength due to heating during the warm press forming are not observed.

In contrast, in the Comparative Example outside our range, (Uniform elongation)/(Total elongation) is lower than 40% in the tensile test carried out at a test temperature of lower than 400° C. (300° C.) and (Local elongation)/(Uniform elongation) is 1.0 or lower in the tensile test carried out at a test temperature of 400° C. or higher (500° C.). Thus, in the Comparative Examples, the warm press formability decreases or the tensile strength significantly decreases due to heating during the warm press forming.

1. A high strength steel sheet with excellent warm stamp formability comprising:
a matrix, which is substantially a ferrite single phase in which an area ratio of the ferrite phase is 95% or more and
a structure in which alloy carbides having a size of lower than 10 nm are dispersed and deposited in the matrix in a state having no variant selection,
wherein the sheet has a tensile strength of 590 MPa or more and tensile properties in which strain from an indication of a maximum load to fracture is larger than the strain before the indication of the maximum load from a start of a tensile test carried out at a test temperature of 400° C. or higher and the strain before the indication of the maximum load from the start of tensile test is 40% or more in terms of ratio to a total elongation from the start of tensile test to fracture obtained in a tensile test carried out at a test temperature of lower than 400° C.

2. The high strength steel sheet according to claim 1, having a composition containing, in terms of % by mass, C: 0.01 to 0.2%, Si: 0.5% or lower, Mn: 2% or lower, P: 0.03% or lower, S: 0.01% or lower, Al: 0.07% or lower, N: 0.01% or lower, and one or two or more elements selected from the group consisting of Ti: 0.005 to 0.3%, Nb: 0.005 to 0.6%, V: 0.005 to 1.0%, Mo: 0.005 to 0.5%, W: 0.01 to 1.0%, and B: 0.0005 to 0.0040% and the balance Fe with inevitable impurities.

3. The high strength steel sheet according to claim 1, wherein the high strength steel sheet has a coated layer on the surface.

4. The high strength steel sheet according to claim 3, wherein the coated layer is a galvanized layer or a galvannealed layer.

5. A method for manufacturing a high strength steel sheet which has a tensile strength of 590 MPa or more and is excellent in warm stamp formability comprising:
successively performing a hot rolling process including heating a steel having a composition comprising, in terms of % by mass, C: 0.01 to 0.2%, Si: 0.5% or lower, Mn: 2% or lower, P: 0.03% or lower, S: 0.01% or lower, Al: 0.07% or lower, N: 0.01% or lower, and one or two or more elements selected from the group consisting of Ti: 0.005 to 0.3%, Nb: 0.005 to 0.6%, V: 0.005 to 1.0%, Mo: 0.005 to 0.5%, W: 0.01 to 1.0%, and B: 0.0005 to 0.0040% and the balance Fe with inevitable impurities to an austenite single phase temperature range;
subjecting the steel sheet to hot rolling at a finish rolling temperature of 860° C. or higher;
coiling the steel sheet at a temperature of 400° C. or higher and lower than 600° C. to form a hot rolled sheet; and
performing a heat treatment process including removing surface scale of the hot rolled sheet, and subjecting the hot rolled sheet to heat treatment in a temperature range of 650 to 750° C.

6. The method according to claim 5, further comprising performing a coating treatment to the hot rolled sheet that is subjected to the heat treatment process.

7. The method according to claim 5, further comprising performing galvanizing treatment or further galvannealing treatment subsequent to the heat treatment process.

8. The high strength steel sheet according to claim 2, wherein the high strength steel sheet has a coated layer on the surface.

9. The high strength steel sheet according to claim 8, wherein the coated layer is a galvanized layer or a galvannealed layer.
